(19) United States
(12) Patent Application Publication
(10) Pub. No.: US 2022/0282087 A1
(43) Pub. Date: Sep. 8, 2022

(54) High-voltage Components

(71) Applicant: LANXESS Deutschland GmbH, Cologne (DE)

(72) Inventors: Jochen Endtner, Cologne (DE); Dirk Schmitz, Weeze (DE); Matthias Bienmueller, Krefeld (DE)

(73) Assignee: LANXESS Deutschland GmbH, Cologne (DE)

(21) Appl. No.: 17/641,146

(22) PCT Filed: Aug. 31, 2020
(86) PCT No.: PCT/EP2020/074234

§ 371 Date: Mar. 8, 2022

(30) Foreign Application Priority Data
Sep. 10, 2019 (EP) 19196333.9

(51) Int. Cl. C08L 77/02; C08K 3/30

(52) U.S. Cl. CPC C08L 77/02; C08K 3/30; C08K 2003/3009

(57) ABSTRACT

The present invention relates to high-voltage components, especially for electromobility, containing polymer compositions based on at least one polyamide and at least one sulfide containing cerium, and to the use thereof for production of polyamide-based high-voltage components or for marking of polyamide-based products as high-voltage components by laser.

The present invention relates to high-voltage components, especially for electromobility, comprising polymer compositions based on at least one polyamide and at least one sulfide containing cerium, and to the use thereof for production of polyamide-based high-voltage components or for marking of polyamide-based products as high-voltage components by laser.

### PRIOR ART

Technical thermoplastics such as polyamides are important materials, particularly also in the field of components for motor vehicles, due to their good mechanical stability, their chemicals resistance, very good electrical properties and good workability.

Polyamides have formed an important constituent for manufacturing demanding motor vehicle components for many years. While the internal combustion engine has been the dominant drive concept for many years, new requirements with regard to choice of materials also arise in the course of the search for alternative drive concepts. A significant role is played here by electromobility, where the internal combustion engine has been replaced partly (hybrid vehicle [HEV, PHEV, BEV Rex]) or completely (electromobile [BEV, FCEV]) by one or more electric motors which typically draw their electrical energy from batteries or fuel cells. While conventional vehicles having an internal combustion engine (ICE) as their sole means of propulsion typically make do with a 12 V onboard voltage system, hybrid and electric vehicles having electric motors as drive unit require significantly higher voltages. This poses a serious additional risk potential for the direct region and the immediate surroundings of such high-voltage parts, which plays an increasingly important role in technical specifications or else in standards. An important role is played here by the unambiguous marking of these dangerous regions in order thus to avoid unintentional contacts with people (driver, mechanic etc.), with unambiguous color marking of such high-voltage assemblies in turn being particularly important.

For instance, the Advanced Vehicle Team of the Idaho National Laboratory for HEV (Hybrid Electric Vehicle) has published a technical specification with recommendations for all apparatuses subject to a high voltage of not less than 60 V including clear marking as “HIGH VOLTAGE”, and in this connection also suggests the color orange for marking (avt.ini.gov/sites/default/files/pdf/hev/hevtechspecr1.pdf).

However, due to the high processing temperatures of in some cases >300° C. during compounding and during injection molding, the choice of suitable colorants for the color orange is very limited, especially for technical thermoplastics such as polyamides.

EP 0 203 838 A2 teaches rare earth metal sulfides as color pigments in thermoplastics or thermosets, specialty polymers, in resins used as a constituent of paints and varnishes, in nail varnishes, and in makeup products used in cosmetics. Example 9 discloses a nylon-6,6-based polymer composition in which Ce₂S₃ is used to achieve the values of L=35.8, a=8.6 and b=1.8 in the RAL color system.

JP 2002 194208 A discloses red polyamide compositions comprising a metal-based inorganic color pigment, wherein the color pigment used may be cerium sulfide.

EP 0 041 274 B1 describes fluorescing compositions capable of altering the wavelengths of the light, molded articles based on such compositions as light wave-transforming elements, and apparatuses for converting optical energy to electrical energy using such an element. The examples of EP 0 041 274 B1 use 12H-phthaloperin-12-one inter alia in polyethylene terephthalate (PET). Furthermore, the use inter alia in polyamides is proposed in EP 0 041 274 B1.

12H-Phthaloperin-12-one [CAS No. 6925-69-5], known as Solvent Orange 60, is obtainable for example as Macrolex® Orange 3G from Lanxess Deutschland GmbH, Cologne. However, a disadvantage is that under extreme demands, especially under the demands seen in electromobility, Solvent Orange 60 has a propensity to migrate out of the plastic matrix, which results in a decline in color intensity at elevated temperatures. The Solvent Orange 60 migrates to the surface of the plastic (blooming). From there it may be rubbed off, washed off or dissolved, may volatilize (fogging) or may migrate into other materials (for example adjacent plastic or rubber parts) (bleeding). The concentration of the Solvent Orange 60 in the original plastic is reduced, thus causing a decline in color intensity. The migrated Solvent Orange 60 also has the disadvantage that it may be transported to adjacent component parts by mechanical or physical processes to cause performance impairment there. Examples include elevated electrical resistance in a switch contact which may result from deposition of Solvent Orange 60 on the surface of electrical contacts. In the field of electrical components, migration of ingredients from plastics is therefore generally undesired since it can affect the properties of the plastics and of spatially adjacent parts, with the result that the function of the electrical component is no longer assured in some cases. Proceeding from the teaching of EP 0 041 274 B1, the problem addressed by the present invention was therefore that of providing orange polymer compositions based on polyamide for high-voltage components, especially for high-voltage components in electrical vehicles, which are less prone to migration, especially bleeding, compared to the solution in EP 0 041 274 B1 based on 12H-phthaloperin-12-one.

Also important for high-voltage components, especially in electromobility, is the possibility of identification in order to identify these with additional information such as serial numbers, manufacturer features, installation information or safety-relevant information. A suitable means of identifying plastic-based components is laser inscription (see de.wikipedia.org/wiki/Laserbeschriftung), preferably using diode lasers or ND:YAG lasers of wavelength 1064 nm.

According to the prior art, in the case of inscriptions with a laser of wavelength 1064 nm, usually antimony trioxide-based additives are used to improve inscription contrast (see EP 3 281 974 A1). However, the use of antimony trioxide should preferably be avoided in accordance with the invention since it has a negative image on the market owing to a H351 hazard statement (“Suspected of causing cancer”). Even antimony trioxide can have an adverse effect on tracking resistance according to IEC 60112, which would be particularly disadvantageous specifically for applications in high-voltage components for electromobility, because, in the case of a relatively low tracking resistance, the distance between current-bearing assemblies would have to be increased in order to rule out safety risks as a result of unwanted current flow.

It is thus an additional object of the present invention for laser inscribability at a laser wavelength of 1064 nm to be possible even without the addition of antimony trioxide or antimony trioxide-containing derivatives, and for there to be no need, if possible, to accept any disadvantages corresponding to antimony trioxide as a result of a decrease in tracking resistance.

Inventive orange polyamide-based molding compounds, as well as laser inscribability, are ideally also to have improved lightfastness and improved thermal stability over the above-cited prior art, in that the original color achieved directly after injection molding is retained over a longer period in each case under UV light or under thermal stress compared to 12H-phthaloperin-12-one. A longer period in relation to thermal stress in the context of the present invention means storage in a hot-air drying cabinet at 80° C. for 12 hours. A longer period in relation to lightfastness in the context of the present invention means an irradiation time with a xenon lamp, 1500 watts, 45-130 klx, and wavelength 300-800 nm for 96 h.

It has now been found that, surprisingly, high-voltage components, especially high-voltage components for electromobility, comprising thermoplastic polymer compositions based on polyamide and at least one sulfide containing cerium as orange colorant meet the demands on bleeding, on lightfastness and on the requisite laser inscribability.

### Subject-Matter of the Invention

The invention provides polymer compositions comprising at least one polyamide and at least one sulfide containing cerium.

Preference is further given to polymer compositions in which, for every 100 parts by mass of polyamide, 0.01 to 5 parts by mass, more preferably 0.01 to 3 parts by mass, of at least one sulfide containing cerium are used.

The invention also provides high-voltage components, especially high-voltage components for electromobility, based on the polymer compositions comprising at least one polyamide and at least one sulfide containing cerium.

The invention also provides high-voltage components, especially high-voltage components for electromobility, based on polymer compositions comprising, for every 100 parts by mass of at least one polyamide, 0.01 to 5 parts by mass, more preferably 0.01 to 3 parts by mass, of at least one sulfide containing cerium.

The present invention also relates to the use of at least one sulfide containing cerium for production of polyamide-based polymer compositions, preferably polyamide-based high-voltage components, especially of polyamide-based high-voltage components for electromobility.

The invention additionally relates to the use of at least one sulfide containing cerium for marking of polyamide-based products as high-voltage components by laser, preferably by diode laser or ND:YAG laser at a wavelength of 1064 nm.

The present invention preferably relates to polymer compositions, to molding compounds to be produced therefrom, and in turn to high-voltage components or high-voltage components for electromobility that are to be produced therefrom, with the proviso that these, in the RAL color system, correspond to color number RAL2003, RAL2004, RAL2007, RAL2008, RAL2009, RAL2010 or RAL2011.

Finally, the present invention relates to a method of marking polyamide-based products as high-voltage components, by using a laser, preferably a diode laser or ND:YAG laser at a wavelength of 1064 nm, to irradiate the products, wherein at least one sulfide containing cerium is used in the polyamide.

The formulation of inventive polyamide-based polymer compositions for use as high-voltage components is effected by mixing the components to be used as reactants, A) polyamide and B) at least one sulfide containing cerium, in at least one mixing system, with the proviso that the polymer compositions or the high-voltage components or high-voltage components for electromobility that are to be produced therefrom on the basis of A) and B), in the RAL color system, correspond to color number RAL2003, RAL2004, RAL2007, RAL2008, RAL2009, RAL2010 or RAL2011.

The mixing affords, as intermediates, molding compounds based on the polymer compositions of the invention. These molding compounds may either consist exclusively of the components A) and B) or else may contain at least one further component in addition to the components A) and B), with the proviso that the molding compounds or the high-voltage components or high-voltage components for electromobility that are to be produced therefrom on the basis of A) and B) and optionally further components, in the RAL color system, correspond to color number RAL2003, RAL2004, RAL2007, RAL2008, RAL2009, RAL2010 or RAL2011.

Preferably, for the reasons given above, the use of antimony-based components, especially the use of antimony trioxide-containing derivatives, is dispensed with in the production of the polymer compositions or molding compounds.

For the sake of clarity, it should be noted that the scope of the present invention encompasses all the definitions and parameters recited in general or in preferred ranges in any desired combinations. The standards cited in the context of this application relate to the current version at the filing date of this invention.

Bleeding

In the context of the present invention, bleeding is ascertained as follows:

Plastic sheets having dimensions of 60.40.2 mm³ are first fabricated from a colorant-containing polyamide composition to be examined. For plastic sheets in the context of the present invention, the color used is at least one sulfide containing cerium. A plasticized PVC film having dimensions of 30.20.2 mm³ is subsequently placed between two of the initially fabricated plastic sheets and the entirety of all sheets is stored at 80° C. for 12 hours in a hot air drying cabinet. The colorant that has migrated from the two plastic sheets into the plasticized PVC is then assessed visually by the gray scale according to ISO 105-A02, with ‘5’ meaning that the PVC film shows no color change (no visually discernible colorant transfer from the polyamide plastic sheets to the PVC film) and ‘1’ meaning that the PVC film shows a significant color change (significant visually discernible colorant transfer from the polyamide plastic sheets to the PVC film).

Lightfastness

The measure of lightfastness used in the context of the present invention is discoloration after UV storage of above-described plastic sheets of the colorant-containing polyamide composition to be examined with UV light of the type from Suntest CPS+ with air-cooled Atlas Xenon lamp, 1500 watts, 45-130 klx, wavelength 300-800 nm and window glass filter 250-267 W/m² from Atlas Material Testing Technology GmbH, Linsengericht, Germany, and an irradiation time of 96 h. Discoloration is evaluated visually based on the blue wool scale according to DIN EN ISO 105-B02, with ‘8’ representing exceptional lightfastness (little color change) and ‘1’ representing very low lightfastness (significant color change).

High Voltage

Regulation no. 100 of the United Nations Economic Commission for Europe (UNECE)—Uniform provisions concerning the approval of vehicles with regard to the specific requirements for the electric power train [2015/505], paragraph 2.17, describes the term “high voltage” as the classification of an electric component or circuit, if its working voltage is >60 V and ≤1500 V (direct current) or >30 V and 1000 V (alternating current) root mean square (rms).

This classification of “high voltage” corresponds to voltage class B of ISO6469-3:2018 (“Electrically propelled road vehicles—Safety specifications—Part 3: Electrical safety”). Section 5.2 thereof also includes marking requirements for electrical components of voltage class B through appropriate hazard symbols or the color ‘orange’.

High-Voltage Components and High-Voltage Components for Electromobility

According to the invention, the term high-voltage component is understood to mean components or articles of manufacture subject to an operating voltage according to section 2.17 of the abovementioned Regulation no. 100 of the United Nations Economic Commission for Europe (UNECE). According to the invention, high-voltage components for electromobility preferably refer to components in electric vehicles subject to an operating voltage of not less than 30 V (direct current) or not less than 20 V (alternating current), more preferably—in accordance with voltage class B of ISO6469-3:2018—an operating voltage of greater than 60 V (direct current) or more than 30 V (alternating current).

According to the invention, high-voltage components for electromobility include not only those components that are in direct contact with the voltage-conducting parts but also those which, directly adjacent thereto or in spatial proximity thereof, act as a touch guard, a warning marker or a shielding means, preference being given in accordance with the invention to components in direct contact with the voltage-conducting parts.

Polymer compositions of the invention, products that are to be produced therefrom, preferably high-voltage components, more preferably high-voltage components for electromobility, on account of the at least one sulfide containing cerium, are orange in color, with particular preference for shades corresponding in the RAL color system to color numbers RAL2003, RAL2004, RAL2007, RAL2008, RAL2009, RAL2010 and RAL2011, very particular preference for the shades corresponding in the RAL color system to color numbers RAL2003, RAL2004, RAL2008 and RAL2009, and especial preference for RAL 2003.

“Similar shades” likewise allowable in accordance with the invention are shades whose color distance in the L*a*b* system has a ΔE of <20, preferably a ΔE<10, more preferably ΔE<5, from the L*a*b* value of a particular RAL shade defined in the RAL color chart. For elucidation of ΔE see for example:

de.wikipedia.org/wiki/Delta_E.

Orange

In the context of the present invention, orange is considered to mean a color which, in the RAL color system according to de.wikipedia.org/wiki/RAL-Farbe#Orange, has a color number beginning with “2” in the RAL color chart. In particular, at the filing date of the present invention a distinction is made between the orange shades according to Table 1:

TABLE 1

| | | L* | a* | b* |
|---|---|---|---|---|
| RAL 2000 | Gelborange | 58.20 | 37.30 | 68.68 |
| RAL 2001 | Rotorange | 49.41 | 39.79 | 35.29 |
| RAL 2002 | Blutorange | 47.74 | 47.87 | 33.73 |
| RAL 2003 | Pastellorange | 66.02 | 41.22 | 52.36 |
| RAL 2004 | Reinorange | 56.89 | 50.34 | 49.81 |
| RAL 2005 | Leuchtorange | 72.27 | 87.78 | 82.31 |
| RAL 2007 | Leuchthellorange | 76.86 | 47.87 | 97.63 |
| RAL 2008 | Hellrotorange | 60.33 | 46.91 | 60.52 |
| RAL 2009 | Verkehrsorange | 55.83 | 47.79 | 48.83 |
| RAL 2010 | Signalorange | 55.39 | 40.10 | 42.42 |
| RAL 2011 | Tieforange | 59.24 | 40.86 | 64.50 |
| RAL 2012 | Lachsorange | 57.75 | 40.28 | 30.66 |
| RAL 2013 | Perlorange | 40.73 | 32.14 | 34.92 |

Table 1 shows the apparatus-independent CIE L*a*b* color values for the respective RAL value: L* stands for luminance, a*=D65 and b*=10°. The color model is standardized in EN ISO 11664-4 “Colorimetry—Part 4: CIE 1976 L*a*b* Color space”. For L*a*b* color space (also: CIELAB) see: de.wikipedia.org/wiki/Lab-Farbraum.

Each color in the color space is defined by a color locus having the Cartesian coordinates {L*, a*, b*}. The a*b* coordinate plane was constructed using opponent color theory. Green and red are at opposite ends of the a* axis from one another and the b* axis runs from blue to yellow. Complementary shades are respectively by 180° opposite one another and the point centrally between them (the coordinate origin a*=0, b*=0) is gray.

The L* axis describes the brightness (luminance) of the color with values of 0 to 100. In the diagram it stands perpendicular to the a*b* plane at the origin. It may also be referred to as the neutral gray axis since all non-colored shades (gray shades) are contained between the endpoints of black (L*=0) and white (L*=100). The a* axis describes the green or red fraction of a color, with negative values representing green and positive values representing red. The b* axis describes the blue or yellow fraction of a color, with negative values representing blue and positive values representing yellow.

The a* values range from approximately −170 to +100 and the b* values from −100 to +150, with the maximum values being achieved only at moderate brightness of certain shades. The CIELAB color space has its greatest extent in the region of moderate brightness, although this differs in height and size depending on the color range.

In the context of the present invention, preference is given to polymer compositions and high-voltage components producible therefrom that have a color number as close as possible, or even corresponding precisely, to RAL 2003, pastel orange with L*a*b* of 66.02/41.22/52.36. To this end, a person skilled in the art will choose the amounts of the components to be used in the polymer compositions according to the invention such that RAL 2003 is ideally achieved as the result.

### Further Preferred Embodiments of the Invention

In a preferred embodiment, the invention relates to polymer compositions, high-voltage components, especially high-voltage components for electromobility, comprising, in addition to components A) and B), also C) at least one filler and/or reinforcer, preferably in an amount of 1 to 150 parts by mass, more preferably 5 to 80 parts by mass, most preferably 10 to 50 parts by mass, based in each case on 100 parts by mass of component A), with the proviso that the polymer compositions and the high-voltage components or high-voltage components for electromobility that are to be produced therefrom, in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003.

In a further preferred embodiment, the invention relates to polymer compositions, high-voltage components, especially high-voltage components for electromobility, comprising, in addition to components A), B) and C), or in place of C), also D) at least one flame retardant, preferably in an amount of 3 to 100 parts by mass, more preferably 5 to 80 parts by mass, most preferably 10 to 50 parts by mass, based in each case on 100 parts by mass of the component A), with the proviso that the polymer compositions and the high-voltage components or high-voltage components for electromobility that are to be produced therefrom, based on A), B), C) and D) or based on A), B) and D), in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003.

In a further preferred embodiment, the invention relates to polymer compositions, high-voltage components, especially high-voltage components for electromobility, comprising, in addition to components A), B), C), D), or in place of C) and/or D), also E) at least one further additive other than components B), C) and D), preferably in an amount of 0.01 to 80 parts by mass, more preferably 0.05 to 50 parts by mass, most preferably 0.1 to 30 parts by mass, based in each case on 100 parts by mass of the component A). E) is preferably used with the proviso that the polymer compositions and the high-voltage components or high-voltage components for electromobility that are to be produced therefrom, based on A), B), C), D) and E) or based on A), B), E) or based on A), B), C) and E) or based on A), B), D) and E), in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003.

Component A)

The polyamides for use in accordance with the invention as component A) may be produced by various methods and synthesized from different monomers. A multitude of procedures for preparing polyamides has become known, it being possible to use, depending on the desired end product, different monomer units and various chain transfer agents to establish a desired molecular weight or else monomers with reactive groups for aftertreatments intended at a later stage.

The processes of industrial relevance for preparation of polyamides usually proceed via polycondensation in the melt. In this context, the hydrolytic polymerization of lactams is also considered to be polycondensation.

Useful reactants include aliphatic and/or aromatic dicarboxylic acids, such as adipic acid, 2,2,4- and 2,4,4-trimethyladipic acid, azelaic acid, sebacic acid, isophthalic acid, terephthalic acid, aliphatic and/or aromatic diamines, for example tetramethylenediamine, hexamethylenediamine, nonane-1,9-diamine, 2,2,4- and 2,4,4-trimethylhexamethylenediamine, the isomeric diaminodicyclohexylmethanes, diaminodicyclohexylpropanes, bisaminomethylcyclohexane, phenylenediamines, xylylenediamines, aminocarboxylic acids, for example aminocaproic acid, or the corresponding lactams. Particular preference is given to using caprolactams, especially ε-caprolactam. Copolyamides of a plurality of the monomers mentioned are included.

Preferred polyamides are semicrystalline polyamides that are preparable proceeding from diamines and dicarboxylic acids and/or lactams having at least 5 ring members or corresponding amino acids.

Particularly preferred polyamides used are nylon-6, nylon-6,6, nylon-4,6 and/or semiaromatic copolyamides. Preferred semiaromatic copolyamides are PA6T/6, PA6T/66, PA6T/6I or PA6T/6I/66.

Polyamides that are very particularly preferred in accordance with the invention are nylon-6 and nylon-6,6, and nylon-6 is very especially preferred. The invention therefore provides preferably high-voltage components, especially high-voltage components for electromobility, based on polymer compositions containing at least one polyamide and at least one sulfide containing cerium, in which the polyamide used is nylon-6 or nylon-6,6, with the proviso that the polymer compositions or the high-voltage components or the high-voltage components for electromobility to be produced therefrom correspond, in the RAL color system, to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003.

The nomenclature of the polyamides used in the context of the present application corresponds to international standard ISO 1874-1, the first number(s) denoting the number of carbon atoms in the starting diamine and the last number(s) denoting the number of carbon atoms in the dicarboxylic acid. If only one number is stated, as in the case of PA6, this means that the starting material was an α,ω-aminocarboxylic acid or the lactam derived therefrom, i.e. ε-caprolactam in the case of PA6.

The PA6 [CAS No. 25038-54-4] for use with preference in accordance with the invention as component A) preferably has a viscosity number determinable to ISO 307 in a 0.5% by weight solution in 96% by weight sulfuric acid at 25° C. in the range from 80 to 180 ml/g, more preferably in the range from 85 to 160 ml/g and most preferably in the range from 90 to 140 ml/g. Nylon-6 for use with preference in accordance with the invention as component A) is available, for example, as Durethan® B26 at Lanxess Deutschland GmbH, Cologne.

A nylon-6,6 [CAS No. 32131-17-2] for use with preference as component A) preferably has a viscosity number determinable to ISO 307 in a 0.5% by weight solution in 96% by weight sulfuric acid at 25° C. in the range from 80 to 180 ml/g, even more preferably a viscosity number in the range from 85 to 160 ml/g, especially preferably in the range from 90 to 140 ml/g. Nylon-6,6 for use in accordance with the invention as component A) is available, for example, as Ultramid® A24E01 at BASF SE, Ludwigshafen.

The polyamide for use in accordance with the invention as component A) may also be used in a mixture with at least one other polyamide, in the form of a copolyamide and/or with at least one other polymer. Preferred other polymers are selected from the group of polyethylene, polypropylene and acrylonitrile-butadiene-styrene copolymer (ABS). In the case of use of at least one further polyamide or at least one other polymer, this is preferably or optionally combined with use of at least one compatibilizer.

It is possible to admix customary additives, preferably demolding agents, stabilizers and/or flow auxiliaries known to the person skilled in the art, already in molten form into the polyamide to be used as component A).

Component B)

According to the invention, at least one sulfide containing cerium is used as component B). Preferred sulfides containing cerium are cerium(III) sulfide (Ce₂S₃) [CAS No. 12014-93-6], also known as C.I. Pigment Orange 75, or cerium(III) sulfide/lanthanum(III) sulfide (Ce₂S₃/La₂S₃) [CAS No. 12014-93-6; CAS No. 12031-49-1], also known as C.I. Pigment Orange 78. The sulfide containing cerium used with particular preference in accordance with the invention is the mixed sulfide cerium(III) sulfide/lanthanum(III) sulfide (CA. Pigment Orange 78). With regard to the C.I. classification see de.wikipedia.org/wiki/Colour_Index.

Pigment Orange 75 and Pigment Orange 78 may be sourced, for example, from Chemikos, Dr. Oliver Schmitt, Karlsruhe, Germany [chemikos.de/cersulfid-orange-pigmente] or under the trade name Neolor® Orange S or Neolor® Light Orange S from Baotou Hongbo Te Technology co. Ltd., ‘Inner Mongolia’, China.

According to the invention, the at least one sulfide containing cerium may be used individually or in a mixture with at least one further sulfide containing cerium, where the invention also encompasses mixed oxides or mixed sulfides of cerium with other lanthanides, preferably with lanthanum, with the proviso that the polymer compositions and the high-voltage components or high-voltage components for electromobility that are to be produced therefrom, in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003.

The at least one sulfide containing cerium to be used in accordance with the invention as component B) may be used directly in component A) as a powder or else in the form of a paste or a masterbatch, compact or concentrate, preference being given to masterbatches, and particular preference to masterbatches in a polymer matrix corresponding to the particular component A).

Component C)

In a preferred embodiment, at least one filler or reinforcer is used as component C). It is also possible here to use mixtures of two or more different fillers or reinforcers.

Preference is given to using at least one filler or reinforcer from the group of carbon fibers [CAS No. 7440-44-0], glass beads or solid or hollow glass beads, glass fibers, ground glass, amorphous quartz glass, aluminum borosilicate glass having an alkali metal content of 1% (E glass) [CAS No. 65997-17-3], amorphous silica [CAS No. 7631-86-9], quartz flour [CAS No. 14808-60-7], calcium silicate [CAS No. 1344-95-2], calcium metasilicate [CAS No. 10101-39-0], magnesium carbonate [CAS No. 546-93-0], kaolin [CAS No. 1332-58-7], calcined kaolin [CAS No. 92704-41-1], chalk [CAS No. 1317-65-3], kyanite [CAS No. 1302-76-7], powdered or ground quartz [CAS No. 14808-60-7], mica [CAS No. 1318-94-1], phlogopite [CAS No. 12251-00-2], barium sulfate [CAS No. 7727-43-7], feldspar [CAS No. 68476-25-5], wollastonite [CAS No. 13983-17-0], montmorillonite [CAS No. 67479-91-8], pseudoboehmite of the formula AlO(OH), magnesium carbonate [CAS No. 12125-28-9] and talc [CAS No. 14807-96-6].

Among the fibrous fillers or reinforcers, glass fibers and wollastonite are particularly preferred, and glass fibers are very particularly preferred. It is also possible to use carbon fibers as filler or reinforcer.

With regard to the glass fibers, the person skilled in the art, according to de.wikipedia.org/wiki/Faser-Kunststoff-Verbund, makes a distinction between chopped fibers, also called short fibers, having a length in the range from 0.1 to 1 mm, long fibers having a length in the range from 1 to 50 mm, and continuous fibers having a length L>50 mm. Short fibers are preferably used in injection molding methodology and may be processed directly with an extruder. Long fibers can likewise still be processed in extruders. Said fibers are widely used in fiber spraying. Long fibers are frequently added to thermosets as a filler. Continuous fibers are used in the form of rovings or fabric in fiber-reinforced plastics. Products comprising continuous fibers achieve the highest stiffness and strength values. Also available are ground glass fibers, the length of which after grinding is typically in the range from 70 to 200 μm.

Glass fibers to be used with preference in accordance with the invention as component C) are chopped long glass fibers having an average starting length to be determined by laser diffractometry to ISO 13320 in the range from 1 to 50 mm, more preferably in the range from 1 to 10 mm, most preferably in the range from 2 to 7 mm. With regard to laser diffraction particle size determination/laser diffractometry according to standard ISO 13320 see: de.wikipedia.org/wiki/Laserbeugungs-Partikelgr%C3%B6% C3%9Fenanalyse

Preferred glass fibers for use as component C) have an average fiber diameter to be determined by laser diffractometry to ISO 13320 in the range from 7 to 18 μm, more preferably in the range from 9 to 15 μm.

In a preferred embodiment, the glass fibers preferred for use as component C) are modified with a suitable size system or an adhesion promoter/adhesion promoter system. Preference is given to using a silane-based size system or adhesion promoter. Particularly preferred silane-based adhesion promoters for the treatment of component E), especially for the treatment of glass fibers, are silane compounds of the general formula (I)

(X—(CH₂)_{q})ₖ—Si—(O—CᵣH₂ᵣ₊₁)₄₋ₖ (I)

in which
X is NH₂—, carboxyl-, HO— or

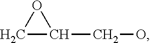

q in formula (I) represents an integer from 2 to 10, preferably 3 to 4,
r in formula (I) represents an integer from 1 to 5, preferably 1 to 2, and
k in formula (I) represents an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane, and the corresponding silanes containing a glycidyl group or a carboxyl group as the X substituent, very particular preference being given to carboxyl groups.

For the modification of the fillers, preferably glass fibers, for use as component C), the adhesion promoters, preferably the silane compounds of formula (I), are used preferably in amounts in the range from 0.05% to 2% by weight, more preferably in amounts in the range from 0.25% to 1.5% by weight and most preferably in amounts in the range from 0.5% to 1% by weight, based in each case on 100% by weight of component C).

The glass fibers to be used with preference as component C), as a result of the processing to give the composition or to give the product, may be shorter in the composition, or in the product, than the glass fibers originally used. Thus, the arithmetic average of the glass fiber length after processing, to be determined by high-resolution x-ray computed tomography, is frequently only in the range from 150 μm to 300 μm.

According to r-g.de/wiki/Glasfasern, glass fibers are produced by the melt-spinning process (die drawing, rod drawing and die blowing processes). In the die drawing process, the hot mass of glass flows under gravity through hundreds of die bores of a platinum spinneret plate. The filaments can be drawn at a speed of 3-4 km/minute with unlimited length.

Those skilled in the art distinguish between different types of glass fibers, some of which are listed here by way of example:
E glass, the most commonly used material having an optimal cost-benefit ratio (E glass from R&G)
H glass, hollow glass fibers for reduced weight (R&G hollow glass fiber fabric 160 g/m² and 216 g/m²)
R, S glass, for elevated mechanical requirements (S2 glass from R&G)
D glass, borosilicate glass for elevated electrical requirements
C glass, having increased chemicals resistance
Quartz glass, having high thermal stability

Further examples can be found at de.wikipedia.org/wiki/Glasfaser. E glass fibers have gained the greatest significance for reinforcement of plastics. E stands for electrical glass, since it was originally used in the electrical industry in particular. For the production of E glass, glass melts are produced from pure quartz with additions of limestone, kaolin and boric acid. As well as silicon dioxide, they contain different amounts of various metal oxides. The composition determines the properties of the products. Preference is given in accordance with the invention to using at least one type of glass fibers from the group of E glass, H glass, R,S glass, D glass, C glass and quartz glass, particular preference to using glass fibers made of E glass.

Glass fibers made of E glass are the most commonly used reinforcing material. The strength characteristics correspond to those of metals (for example aluminum alloys) wherein the specific weight of laminates containing E glass fibers is lower than that of metals. E glass fibers are nonflammable, heat resistant up to about 400° C. and stable to most chemicals and weathering effects.

Further preferably used as component C) are also acicular mineral fillers. Acicular mineral fillers are understood in accordance with the invention to mean a mineral filler with a highly pronounced acicular character. The acicular mineral filler preferred for use as component C) is wollastonite. The acicular mineral filler preferably has a length:diameter ratio to be determined by high-resolution x-ray computed tomography in the range from 2:1 to 35:1, more preferably in the range from 3:1 to 19:1, especially preferably in the range from 4:1 to 12:1. The average particle size of the acicular mineral fillers for determination by high-resolution x-ray computed tomography is preferably less than 20 μm, particularly preferably less than 15 μm, especially preferably less than 10 μm.

Preference is alternatively given to using, as component C), non-fibrous and non-foamed ground glass having a particle size distribution to be determined by laser diffractometry to ISO 13320 with a d90 in the range from 5 to 250 μm, preferably with a d90 in the range from 10 to 150 μm, more preferably with a d90 in the range from 15 to 80 μm, most preferably with a d90 in the range from 16 to 25 μm. In terms of the d90 values, their determination and their significance, reference is made to Chemie Ingenieur Technik (72) pp. 273-276, 3/2000, Wiley-VCH Verlags GmbH, Weinheim, 2000, according to which the d90 value is that particle size below which 90% of the amount of particles lie.

Preferably in accordance with the invention, the non-fibrous and non-foamed ground glass is of particulate, non-cylindrical shape and has a length to thickness ratio to be determined by laser diffractometry to ISO 13320 of less than 5, preferably less than 3, more preferably less than 2. The value of zero is of course impossible.

The non-foamed and non-fibrous ground glass to be used with particular preference as component C) in one embodiment is additionally characterized in that it does not have the glass geometry typical of fibrous glass with a cylindrical or oval cross section having a length to diameter ratio (L/D ratio) to be determined by laser diffractometry to ISO 13320 of greater than 5.

The non-foamed and non-fibrous ground glass to be used with particular preference in accordance with the invention as component C) in one embodiment is preferably obtained by grinding glass with a mill, preferably a ball mill and more preferably with subsequent sifting or sieving. Preferred starting materials for the grinding of the non-fibrous and non-foamed ground glass for use as component C) in one embodiment also include glass wastes as generated as unwanted by-product and/or as off-spec primary product (called offspec material), especially in the production of glass products. These especially include waste glass, recycled glass and broken glass as can be obtained especially in the production of window or bottle glass, and in the production of glass-containing fillers and reinforcers, especially in the form of what are called melt cakes. The glass may be colored, but preference is given to non-colored glass as the starting material for use as component C).

Component D)

In a preferred embodiment, at least one flame retardant is used as component D). Preferred flame retardants are mineral flame retardants, nitrogen-containing flame retardants or phosphorus-containing flame retardants other than component C).

Among the mineral flame retardants, magnesium hydroxide is particularly preferred. Magnesium hydroxide [CAS No. 1309-42-8] may be impure as a result of its origin and mode of production. Typical impurities include, for example, silicon-, iron-, calcium- and/or aluminum-containing species which may be intercalated, for example, in the form of oxides in the magnesium hydroxide crystals. The magnesium hydroxide for use as a mineral flame retardant may be unsized or else sized. A size has a beneficial effect on the quality of the mechanical bonding between plastic (matrix) and the component to be provided with the size. The magnesium hydroxide to be used with preference as a mineral flame retardant is preferably provided with sizes based on stearates or aminosiloxanes, more preferably with aminosiloxanes. Magnesium hydroxide for use with preference as a mineral flame retardant has a median particle size d50 to be determined by laser diffractometry to ISO 13320 in the range from 0.5 μm to 6 μm, preference being given to a d50 in the range from 0.7 μm to 3.8 μm and particular preference to a d50 in the range from 1.0 μm to 2.6 μm.

Magnesium hydroxide types suitable as a mineral flame retardant according to the invention include for example Magnifin® HSIV from Martinswerk GmbH, Bergheim, Germany or Hidromag® Q2015 TC from Penoles, Mexico City, Mexico.

Preferred nitrogen-containing flame retardants are the reaction products of trichlorotriazine, piperazine and morpholine of CAS No. 1078142-02-5, especially MCA PPM Triazine HF from MCA Technologies GmbH, Biel-Benken, Switzerland, and also melamine cyanurate and condensation products of melamine, in particular melem, melam, melon or more highly condensed compounds of this type. Preferred inorganic nitrogen-containing compounds are ammonium salts.

In addition, it is also possible to use salts of aliphatic and aromatic sulfonic acids and mineral flame retardant additives, especially aluminum hydroxide or Ca—Mg carbonate hydrates (DE-A 4 236 122).

Also suitable for use as component D) are flame retardant synergists from the group of oxygen-, nitrogen- or sulfur-containing metal compounds. Preferred among these are zinc-free compounds, especially molybdenum oxide, magnesium oxide, magnesium carbonate, calcium carbonate, calcium oxide, titanium nitride, magnesium nitride, calcium phosphate, calcium borate, magnesium borate or mixtures thereof.

However, in an alternative embodiment, it is also possible to use zinc-containing compounds as component D) if required. These preferably include zinc oxide, zinc borate, zinc stannate, zinc hydroxystannate, zinc sulfide and zinc nitride, or mixtures thereof.

Preferred phosphorus-containing flame retardants are organic metal phosphinates, aluminum salts of phosphonic acid, red phosphorus, inorganic metal hypophosphites, metal phosphonates, derivatives of 9,10-dihydro-9-oxa-10-phosphaphenanthrene 10-oxides (DOPO derivatives), resorcinol bis(diphenyl phosphate) (RDP) including oligomers, bisphenol A bis(diphenyl phosphate) (BDP) including oligomers, melamine pyrophosphate, melamine polyphosphate, melamine poly(aluminum phosphate), melamine poly(zinc phosphate) or phenoxyphosphazene oligomers and mixtures thereof.

A preferred organic metal phosphinate is aluminum tris(diethylphosphinate). A preferred inorganic metal hypophosphite is aluminum hypophosphite.

Further flame retardants for use as component D) are char formers, particularly preferably phenol-formaldehyde resins, polycarbonates, polyimides, polysulfones, polyether sulfones or polyether ketones, and also antidrip agents, in particular tetrafluoroethylene polymers.

The flame retardants to be used as component D) may be added to component A) in pure form, or else via masterbatches or compactates.

However, in an alternative embodiment—if required and taking into account the disadvantages of loss of freedom from halogen of the flame retardants—halogen-containing flame retardants may also be used as flame retardants. Preferred halogen-containing flame retardants are commercially available organic halogen compounds, more preferably ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene or brominated polyphenylene ethers, which can be used alone or in combination with synergists, particular preference being given to brominated polystyrene among the halogenated flame retardants. Brominated polystyrene is used in amounts of preferably 10-30% by weight, more preferably 15-25% by weight, based in each case on the overall composition, where at least one of the other components is reduced to such an extent that the sum total of all weight percentages is always 100.

In a further alternative embodiment, flame retardant synergists used may alternatively—if required and taking account of the disadvantages described at the outset with regard to the H351 classification and the effects on tracking resistance that are disadvantageous under some circumstances—also be antimony trioxide and antimony pentoxide.

Brominated polystyrene is commercially available in a very wide variety of product qualities. Examples thereof are for example Firemaster® PBS64 from Lanxess, Cologne, Germany and Saytex® HP-3010 from Albemarle, Baton Rouge, USA.

Among the flame retardants for use as component D), very particular preference is given to aluminum tris(diethylphosphinate) [CAS No. 225789-38-8] and the combination of aluminum tris(diethylphosphinate) and melamine polyphosphate or the combination of aluminum tris(diethylphosphinate) and at least one aluminum salt of phosphonic acid, the latter combination being especially preferred.

In the case of combinations of aluminum tris(diethylphosphinate) and melamine polyphosphate or of aluminum tris(diethylphosphinate) and at least one aluminum salt of phosphonic acid, the proportion of aluminum tris(diethylphosphinate) is preferably in the range from 40 to 90 parts by weight, more preferably in the range from 50 to 80 parts by weight, most preferably in the range from 60 to 70 parts by weight, based in each case on 100 parts by weight of the combination of aluminum tris(diethylphosphinate) and melamine polyphosphate or the combination of aluminum tris(diethylphosphinate) and at least one aluminum salt of phosphonic acid.

Aluminium tris(diethylphosphinate) to be used as component D) is known to the person skilled in the art as Exolit® OP1230 or Exolit® OP1240 from Clariant International Ltd. Muttenz, Switzerland. Melamine polyphosphate is commercially available in a wide variety of product qualities. Examples thereof are for example Melapur® 200/70 from BASF, Ludwigshafen, Germany, and also Budit® 3141 from Budenheim, Budenheim, Germany.

Preferred aluminum salts of phosphonic acid are selected from the group of

primary aluminum phosphonate [Al(H₂PO₃)₃],
basic aluminum phosphonate [Al((OH)H₂PO₃)₂.2H₂O],
Al₂(HPO₃)₃.x Al₂O₃.nH₂O with x in the range from 2.27 to 1 and n in the range from 0 to 4,
Al₂(HPO₃)₃.(H₂O)_{q} of the formula (II) with q in the range from 0 to 4, especially aluminum phosphonate tetrahydrate [Al₂(HPO₃)₃.4H₂O] or secondary aluminum phosphonate [Al₂(HPO₃)₃],
Al₂M_{z}(HPO₃)_{y}(OH)ᵥ.(H₂O)_{w} of the formula (III) in which M denotes alkali metal ion(s) and z is in the range from 0.01 to 1.5, y is in the range from 2.63-3.5, v is in the range from 0 to 2 and w is in the range from 0 to 4, and
Al₂(HPO₃)ᵤ(H₂PO₃)ₜ.(H₂O)ₛ of the formula (IV) in which u is in the range from 2 to 2.99, t is in the range from 2 to 0.01 and s is in the range from 0 to 4,
where z, y and v in formula (III) and u and tin formula (IV) can assume only such numbers that the corresponding aluminum salt of phosphonic acid as a whole is uncharged.

Preferred alkali metals M in formula (III) are sodium and potassium.

The aluminum salts of phosphonic acid described may be used individually or in a mixture. Particularly preferred aluminum salts of phosphonic acid are selected from the group of

primary aluminum phosphonate [Al(H₂PO₃)₃],
secondary aluminum phosphonate [Al₂(HPO₃)₃],
basic aluminum phosphonate [Al((OH)H₂PO₃)₂.2H₂O],
aluminum phosphonate tetrahydrate [Al₂(HPO₃)₃.4H₂O] and
Al₂(HPO₃)₃.x Al₂O₃.n H₂O with x in the range from 2.27 to 1 and n in the range from 0 to 4.

Very particular preference is given to secondary aluminum phosphonate Al₂(HPO₃)₃ [CAS No. 71449-76-8] and secondary aluminum phosphonate tetrahydrate Al₂(HPO₃)₃.4H₂O [CAS No. 156024-71-4], secondary aluminum phosphonate Al₂(HPO₃)₃ being especially preferred.

The preparation of aluminum salts of phosphonic acid for use in accordance with the invention as component D) is described, for example, in WO 2013/083247 A1. It typically comprises reacting an aluminum source, preferably aluminum isopropoxide, aluminum nitrate, aluminum chloride or aluminum hydroxide, with a phosphorus source, preferably phosphonic acid, ammonium phosphonate, alkali metal phosphonate, and optionally with a template in a solvent at 20° C. to 200° C. over a period of up to 4 days. For this purpose, aluminum source and phosphorus source are mixed, heated under hydrothermal conditions or at reflux, filtered off, washed and dried. Preferred templates are hexane-1,6-diamine, guanidine carbonate or ammonia. A preferred solvent is water.

Component E)

At least one further additive other than components B) to D) is used as component E). Preferred additives for use as component E) are antioxidants, thermal stabilizers, UV stabilizers, gamma ray stabilizers, components for reducing water absorption or hydrolysis stabilizers, antistats, emulsifiers, nucleating agents, plasticizers, processing auxiliaries, impact modifiers, lubricants and/or demolding agents, components for reducing water absorption, flow auxiliaries or elastomer modifiers, chain-extending additives, colorants other than component B) and, if required, further laser absorbers. The additives can be used alone or in a mixture, or in the form of masterbatches.

Preferred thermal stabilizers of component E) are sterically hindered phenols, in particular those containing at least one 2,6-di-tert-butylphenyl and/or 2-tert-butyl-6-methylphenyl group, and also phosphites, hypophosphites, especially sodium hypophosphite NaH₂PO₂, hydroquinones, aromatic secondary amines, substituted resorcinols, salicylates, benzotriazoles and benzophenones, 3,3′-thiodipropionic esters and variously substituted representatives of these groups or mixtures thereof.

In one embodiment, thermal stabilizers used in component E) may also be copper salts, preferably in combination with sodium hypophosphite NaH₂PO₂. The copper salt used is preferably copper(I) iodide [CAS No. 7681-65-4] and/or (triphenylphosphino)copper iodide [CAS No. 47107-74-4]. Preference is given to using the copper salts in combination with sodium hypophosphite NaH₂PO₂ or with at least one alkali metal iodide. Preferred alkali metal iodide is potassium iodide [CAS No. 7681-11-0].

Thermal stabilizers for use as component E) are used in amounts of preferably 0.01 to 2 parts by mass, more preferably 0.05 to 1 part by mass, based in each case on 100 parts by mass of component A).

UV stabilizers to be used as component E) are preferably substituted resorcinols, salicylates, benzotriazoles and benzophenones, HALS derivatives (“Hindered Amine Light Stabilizers”) containing at least one 2,2,6,6-tetramethyl-4-piperidyl unit or benzophenones.

UV stabilizers for use as component E) are used in amounts of preferably 0.01 to 2 parts by mass, more preferably 0.1 to 1 part by mass, based in each case on 100 parts by mass of component A).

In one embodiment, colorants other than component B) that are to be used as component E) are preferably inorganic pigments, more preferably ultramarine blue, bismuth metavanadate [CAS No. 14059-33-7], iron oxide [CAS No. 1309-37-1], titanium dioxide [CAS No. 13463-67-7 (rutile) or CAS No. 1317-70-0 (anatase)], barium sulfate [CAS No. 7727-43-7], zinc sulfide [CAS No. 1314-98-3] or tin titanium zinc oxides [CAS No. 923954-49-8], barium sulfate being especially preferred.

In one embodiment, colorants other than component B) that are to be used as component E) are preferably organic colorants, more preferably phthalocyanines, quinacridones, benzimidazoles, especially Ni-2-hydroxynapthylbenzimidazole [CAS No. 42844-93-9] and/or pyrimidine-azo-benzimidazole [CAS No. 72102-84-2] and/or Pigment Yellow 192 [CAS No. 56279-27-7], and also perylenes, anthraquinones, especially C.I. Solvent Yellow 163 [CAS No. 13676-91-0].

The list of inorganic or organic to be used as component E) is not conclusive.

In one embodiment, where required, carbon black or nigrosin may also be used as colorant.

In a preferred embodiment, titanium dioxide is used for component E) as titanium white colorant, also referred to as Pigment White 6 or CI 77891.

Nucleating agents to be used as component E) are preferably sodium phenylphosphinate or calcium phenylphosphinate, aluminum oxide or silicon oxide, and most preferably talc, this enumeration being non-conclusive.

Flow auxiliaries to be used as component E) are preferably copolymers of at least one α-olefin with at least one methacrylic ester or acrylic ester of an aliphatic alcohol. Particular preference is given here to copolymers in which the α-olefin has been formed from ethene and/or propene and the methacrylic ester or acrylic ester contains, as its alcohol component, linear or branched alkyl groups having 6 to 20 carbon atoms. Very particular preference is given to 2-ethylhexyl acrylate. Features of the copolymers suitable as flow auxiliaries are not just their composition but also their low molecular weight. Accordingly, suitable copolymers for the polymer compositions that are to be protected from thermal degradation in accordance with the invention are particularly those that have an MFI value measured at 190° C. and a load of 2.16 kg of at least 100 g/10 min, preferably of at least 150 g/10 min, more preferably of at least 300 g/10 min. The MFI, melt flow index, characterizes the flow of a melt of a thermoplastic and is governed by the standards ISO 1133 or ASTM D 1238. The flow auxiliary used is especially preferably a copolymer of ethene and 2-ethylhexyl acrylate with MFI 550, known as Lotryl® 37EH550.

Chain-extending additives to be used as component E) are preferably di- or polyfunctional branching or chain-extending additives containing at least two branching or chain-extending functional groups per molecule. Preferred branching or chain-extending additives include low molecular weight or oligomeric compounds which have at least two chain-extending functional groups per molecule which are capable of reacting with primary and/or secondary amino groups and/or amide groups and/or carboxylic acid groups. Chain-extending functional groups are preferably isocyanates, alcohols, blocked isocyanates, epoxides, maleic anhydride, oxazoline, oxazine, oxazolone, preference being given to epoxides.

Especially preferred di- or polyfunctional branching or chain-extending additives are diepoxides based on diglycidyl ethers (bisphenol and epichlorohydrin), based on amine epoxy resin (aniline and epichlorohydrin), based on diglycidyl esters (cycloaliphatic dicarboxylic acids and epichlorohydrin), separately or in mixtures, and also 2,2-bis[p-hydroxyphenyl]propane diglycidyl ether, bis[p-(N-methyl-N-2,3-epoxypropylamino)phenyl]methane and epoxidized fatty acid esters of glycerol comprising at least two epoxy groups per molecule.

Particularly preferred di- or polyfunctional branching or chain-extending additives are glycidyl ethers, very particularly preferably bisphenol A diglycidyl ether [CAS No. 98460-24-3] or epoxidized fatty acid esters of glycerol and also very particularly preferably epoxidized soya oil [CAS No. 8013-07-8] and/or epoxidized linseed oil.

Plasticizers preferred for use as component E) are dioctyl phthalate, dibenzyl phthalate, butyl benzyl phthalate, hydrocarbon oils or N-(n-butyl)benzenesulfonamide.

Elastomer modifiers to be used with preference as component E) include one or more graft polymers of
E.1 5% to 95% by weight, preferably 30% to 90% by weight, of at least one vinyl monomer and
E.2 95% to 5% by weight, preferably 70% to 10% by weight, of one or more graft bases having glass transition temperatures <10° C., preferably <0° C., more preferably <−20° C., where the percentages by weight are based on 100% by weight of elastomer modifier.

The graft base E.2 generally has a median particle size d50 value to be determined by laser diffractometry to ISO 13320 in the range from 0.05 to 10 μm, preferably in the range from 0.1 to 5 μm, more preferably in the range from 0.2 to 1 μm.

Monomers E.1 are preferably mixtures of
E.1.1 50% to 99% by weight of vinylaromatics and/or ring-substituted vinylaromatics, in particular styrene, α-methylstyrene, p-methylstyrene, p-chlorostyrene, and/or (C₁-C₈)-alkyl methacrylates, in particular methyl methacrylate, ethyl methacrylate and
E.1.2 1% to 50% by weight of vinyl cyanides, in particular unsaturated nitriles such as acrylonitrile and methacrylonitrile and/or (C₁-C₈)-alkyl (meth)acrylates, in particular methyl methacrylate, glycidyl methacrylate, n-butyl acrylate, t-butyl acrylate, and/or derivatives, in particular anhydrides and imides of unsaturated carboxylic acids, in particular maleic anhydride or N-phenylmaleimide, where the percentages by weight are based on 100% by weight of elastomer modifier.

Preferred monomers E.1.1 are selected from at least one of the monomers styrene, α-methylstyrene and methyl methacrylate; preferred monomers E.1.2 are selected from at least one of the monomers acrylonitrile, maleic anhydride, glycidyl methacrylate and methyl methacrylate. Particularly preferred monomers are E.1.1 styrene and E.1.2 acrylonitrile.

Graft bases E.2 suitable for the graft polymers for use in the elastomer modifiers are, for example, diene rubbers, EPDM rubbers, i.e. those based on ethylene/propylene and optionally diene, and also acrylate, polyurethane, silicone, chloroprene and ethylene/vinyl acetate rubbers. EPDM stands for ethylene-propylene-diene rubber.

Preferred graft bases E.2 are diene rubbers, especially based on butadiene, isoprene, etc., or mixtures of diene rubbers or copolymers of diene rubbers or mixtures thereof with further copolymerizable monomers, especially of E.1.1 and E.1.2, with the proviso that the glass transition temperature of the component E.2 is <10° C., preferably <0° C., more preferably <−10° C.

Particularly preferred graft bases E.2 are ABS polymers (emulsion, bulk and suspension ABS), where ABS stands for acrylonitrile-butadiene-styrene, as described, for example, in DE-A 2 035 390 or in DE-A 2 248 242 or in Ullmann, Enzyklopädie der Technischen Chemie, vol. 19 (1980), p. 277-295. The gel content of the graft base E.2 is preferably at least 30% by weight, more preferably at least 40% by weight (measured in toluene).

The elastomer modifiers/graft polymers for use as component E) are produced by free-radical polymerization, preferably by emulsion, suspension, solution or bulk polymerization, in particular by emulsion or bulk polymerization.

Particularly suitable graft rubbers also include ABS polymers, which are produced by redox initiation with an initiator system composed of organic hydroperoxide and ascorbic acid according to U.S. Pat. No. 4,937,285.

Since, as is well known, the graft monomers are not necessarily completely grafted onto the graft base in the grafting reaction, graft polymers are also understood in accordance with the invention to mean products that result from (co)polymerization of the graft monomers in the presence of the graft base and are also obtained in the workup.

Likewise suitable acrylate rubbers are based on graft bases E.2 that are preferably polymers of alkyl acrylates, optionally having up to 40% by weight, based on E.2, of other polymerizable, ethylenically unsaturated monomers. The preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, such as chloroethyl acrylate, glycidyl esters, and mixtures of these monomers. Particular preference is given here to graft polymers with butyl acrylate as core and methyl methacrylates as shell, in particular Paraloid® EXL2300, Dow Corning Corporation, Midland Mich., USA.

As an alternative to the ethylenically unsaturated monomers, crosslinking may be achieved by copolymerizing monomers having more than one polymerizable double bond. Preferred crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes; but also triallyl phosphate and diallyl phthalate.

Particularly preferred crosslinking monomers are allyl methacrylate, ethylene glycol dimethacrylate, diallyl phthalate and heterocyclic compounds having at least 3 ethylenically unsaturated groups.

Very particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5% by weight, especially 0.05% to 2% by weight, based on the graft base E.2.

In the case of cyclic crosslinking monomers having at least 3 ethylenically unsaturated groups, it is advantageous to restrict the amount to less than 1% by weight of the graft base E.2.

Preferred “other” polymerizable, ethylenically unsaturated monomers which, in addition to the acrylic esters, may optionally be used to produce the graft base E.2 are acrylonitrile, styrene, α-methylstyrene, acrylamides, vinyl C₁-C₆-alkyl ethers, methyl methacrylate, glycidyl methacrylate, butadiene. Preferred acrylate rubbers as graft base E.2 are emulsion polymers having a gel content of at least 60% by weight.

Further graft bases E.2 that are suitable with preference are silicone rubbers having graft-active sites, as described in DE-A 3 704 657, DE-A 3 704 655, DE-A 3 631 540 and DE-A 3 631 539.

Preferred graft polymers with a silicone content are those having methyl methacrylate or styrene-acrylonitrile as the shell and a silicone/acrylate graft as the core. Styrene-acrylonitrile to be used with preference as the shell is Metablen® SRK200. Methyl methacrylate to be used with preference as the shell is Metablen® S2001 or Metablen® S2030 or Metablen® SX-005. Particular preference is given to using Metablen® S2001. The products having the Metablen® trade name are available from Mitsubishi Rayon Co., Ltd., Tokyo, Japan.

Crosslinking may be achieved by copolymerizing monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes; but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5% by weight, especially 0.05% to 2% by weight, based on the graft base E.2.

In the case of cyclic crosslinking monomers having at least 3 ethylenically unsaturated groups, it is advantageous to restrict the amount to less than 1% by weight of the graft base E.2.

Preferred “other” polymerizable, ethylenically unsaturated monomers which, in addition to the acrylic esters, may optionally be used to produce the graft base E.2 are acrylonitrile, styrene, α-methylstyrene, acrylamides, vinyl C₁-C₆-alkyl ethers, methyl methacrylate, glycidyl methacrylate, butadiene. Preferred acrylate rubbers as graft base E.2 are emulsion polymers having a gel content of at least 60% by weight.

In addition to elastomer modifiers based on graft polymers, it is likewise possible to use elastomer modifiers which are not based on graft polymers and which have glass transition temperatures of <10° C., preferably <0° C., more preferably <−20° C. These preferably include elastomers having a block copolymer structure, and additionally thermoplastically meltable elastomers, especially EPM, EPDM and/or SEBS rubbers (EPM=ethylene-propylene copolymer, EPDM=ethylene-propylene-diene rubber and SEBS=styrene-ethene-butene-styrene copolymer).

Lubricants and/or demolding agents for use as component E) are preferably long-chain fatty acids, especially stearic acid or behenic acid, salts thereof, especially calcium stearate or zinc stearate, and the ester derivatives thereof, especially those based on pentaerythritol, especially fatty acid esters of pentaerythritol or amide derivatives, especially ethylenebisstearylamide, montan waxes and low molecular weight polyethylene or polypropylene waxes.

Montan waxes in the context of the present invention are mixtures of straight-chain saturated carboxylic acids having chain lengths of 28 to 32 carbon atoms.

According to the invention, particular preference is given to using lubricants and/or demolding agents from the group of esters of saturated or unsaturated aliphatic carboxylic acids having 8 to 40 carbon atoms with aliphatic saturated alcohols or amides of amines having 2 to 40 carbon atoms with unsaturated aliphatic carboxylic acids having 8 to 40 carbon atoms or instead of the respective carboxylic acids metal salts of saturated or unsaturated aliphatic carboxylic acids having 8 to 40 carbon atoms.

Lubricants and/or demolding agents to be used with very particular preference as component E) are to be selected from the group of pentaerythritol tetrastearate [CAS No. 115-83-3], ethylenebisstearylamide, calcium stearate and ethylene glycol dimontanate. The use of calcium stearate [CAS No. 1592-23-0] or ethylenebisstearylamide [CAS No. 110-30-5] is especially preferred. The use of ethylenebisstearylamide (Loxiol® EBS from Emery Oleochemicals) is very especially preferred.

Hydrolysis stabilizers/components for reducing water absorption preferred for use as component E) are preferably polyesters, wherein polybutylene terephthalate and/or polyethylene terephthalate are preferred and polyethylene terephthalate is very particularly preferred. The polyesters are used preferably in concentrations of 5% to 20% by weight and more preferably in concentrations of 7% to 15% by weight, based in each case on the overall polymer composition and with the proviso that the sum total of all percentages by weight of the polymer composition is always 100% by weight.

Laser absorbers to be used with preference as component E) are preferably selected from the group of tin oxide, tin orthophosphate, barium titanate, aluminum oxide, copper hydroxyphosphate, copper orthophosphate, potassium copper diphosphate, copper hydroxide, bismuth trioxide and anthraquinone. Particular preference is given to tin oxide.

In an alternative embodiment, the laser absorber used may alternatively—if required, taking account of the disadvantages described at the outset with regard to the H351 hazard classification and the disadvantageous effects on tracking resistance—also be antimony tin oxide, antimony trioxide or antimony pentoxide.

The laser absorber may be used directly as a powder or in the form of masterbatches. Preferred masterbatches are those based on polyamide and/or polyolefins, preferably polyethylene. The laser absorber is very particularly preferably used in the form of a nylon-6-based masterbatch.

The laser absorber may be used individually or as a mixture of two or more laser absorbers.

Laser absorbers can absorb laser light of a particular wavelength. In practice, this wavelength is in the range from 157 nm to 10.6 μm. Examples of lasers of these wavelengths are described in WO2009/003976 A1. Preference is given to using Nd:YAG lasers, which can achieve wavelengths of 1064, 532, 355 and 266 nm, and CO₂ lasers.

Preference is given in accordance with the invention to high-voltage components, especially high-voltage components for electromobility, based on polymer compositions comprising
A) per 100 parts by mass of at least one polyamide, preferably nylon-6 or nylon-6,6, especially nylon-6,
B) 0.01 to 5 parts by mass of at least one sulfide containing cerium, and
C) 1 to 150 parts by mass of at least one filler or reinforcer to be selected from the group of glass beads or solid or hollow glass beads, or glass fibers, or ground glass, amorphous quartz glass, aluminum borosilicate glass having an alkali content of 1% (E glass), amorphous silica, quartz flour, calcium silicate, calcium metasilicate, magnesium carbonate, kaolin, calcined kaolin, chalk, kyanite, powdered or ground quartz, mica, phlogopite, barium sulfate, feldspar, wollastonite, montmorillonite, pseudoboehmite of the formula AlO(OH), magnesium carbonate and talc, especially glass fibers,
   with the proviso that the high-voltage components or high-voltage components for electromobility, in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003.

Preference is given in accordance with the invention to high-voltage components, especially high-voltage components for electromobility, based on polymer compositions comprising

A) per 100 parts by mass of at least one polyamide, preferably nylon-6 or nylon-6,6, especially nylon-6,
B) 0.01 to 5 parts by mass of at least one sulfide containing cerium, and
C) 0.01 to 2 parts by mass of at least titanium dioxide,
with the proviso that the high-voltage components or high-voltage components for electromobility, in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003.

Preference is given in accordance with the invention to high-voltage components, especially high-voltage components for electromobility, based on polymer compositions comprising

A) per 100 parts by mass of at least one polyamide, preferably nylon-6 or nylon-6,6, especially nylon-6,
B) 0.01 to 5 parts by mass of at least cerium(III)sulfide (Ce₂S₃) or cerium(III)sulfide/lanthanum(III)sulfide, and
C) 0.01 to 2 parts by mass of at least titanium dioxide,
with the proviso that the high-voltage components or high-voltage components for electromobility, in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003. Particular preference is given in accordance with the invention to high-voltage components, especially high-voltage components for electromobility, based on polymer compositions comprising
A) per 100 parts by mass of at least one polyamide, preferably nylon-6 or nylon-6,6, especially nylon-6,
B) 0.01 to 5 parts by mass of at least cerium(III)sulfide (Ce₂S₃) or cerium(III)sulfide/lanthanum(III)sulfide, and
C) 1 to 150 parts by mass of at least one filler or reinforcer to be selected from the group of glass beads or solid or hollow glass beads, or glass fibers, or ground glass, amorphous quartz glass, aluminum borosilicate glass having an alkali content of 1% (E glass), amorphous silica, quartz flour, calcium silicate, calcium metasilicate, magnesium carbonate, kaolin, calcined kaolin, chalk, kyanite, powdered or ground quartz, mica, phlogopite, barium sulfate, feldspar, wollastonite, montmorillonite, pseudoboehmite of the formula AlO(OH), magnesium carbonate and talc, especially glass fibers, and
with the proviso that the high-voltage components or high-voltage components for electromobility, in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003.

Preference is given in accordance with the invention to high-voltage components, especially high-voltage components for electromobility, based on polymer compositions comprising

A) per 100 parts by mass of at least one polyamide, preferably nylon-6 or nylon-6,6, especially nylon-6,
B) 0.01 to 5 parts by mass of at least one sulfide containing cerium,
C) 1 to 150 parts by mass of at least one filler or reinforcer preferably to be selected from the group of glass beads or solid or hollow glass beads, or glass fibers, or ground glass, amorphous quartz glass, aluminum borosilicate glass having an alkali content of 1% (E glass), amorphous silica, quartz flour, calcium silicate, calcium metasilicate, magnesium carbonate, kaolin, calcined kaolin, chalk, kyanite, powdered or ground quartz, mica, phlogopite, barium sulfate, feldspar, wollastonite, montmorillonite, pseudoboehmite of the formula AlO(OH), magnesium carbonate and talc, especially glass fibers, and
D) 3 to 100 parts by mass of at least one flame retardant additive, preferably to be selected from mineral flame retardants, nitrogen-containing flame retardants or phosphorus-containing flame retardants,
with the proviso that the high-voltage components or high-voltage components for electromobility, in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003.

Particular preference is given in accordance with the invention to high-voltage components, especially high-voltage components for electromobility, based on polymer compositions comprising

A) per 100 parts by mass of at least one polyamide, preferably nylon-6 or nylon-6,6 especially nylon-6,
B) 0.01 to 5 parts by mass of at least cerium(III)sulfide (Ce₂S₃) or cerium (III)sulfide/lanthanum(III)sulfide,
C) 1 to 150 parts by mass of at least one filler or reinforcer preferably to be selected from the group of glass beads or solid or hollow glass beads, or glass fibers, or ground glass, amorphous quartz glass, aluminum borosilicate glass having an alkali content of 1% (E glass), amorphous silica, quartz flour, calcium silicate, calcium metasilicate, magnesium carbonate, kaolin, calcined kaolin, chalk, kyanite, powdered or ground quartz, mica, phlogopite, barium sulfate, feldspar, wollastonite, montmorillonite, pseudoboehmite of the formula AlO(OH), magnesium carbonate and talc, especially glass fibers, and
D) 3 to 100 parts by mass of at least one flame retardant additive, preferably to be selected from mineral flame retardants, nitrogen-containing flame retardants or phosphorus-containing flame retardants,
with the proviso that the high-voltage components or high-voltage components for electromobility, in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003.

Preference is given in accordance with the invention to high-voltage components, especially high-voltage components for electromobility, based on polymer compositions comprising

A) per 100 parts by mass of at least one polyamide, preferably nylon-6 or nylon-6,6, especially nylon-6,
B) 0.01 to 5 parts by mass of at least one sulfide containing cerium,
C) 1 to 150 parts by mass of at least one filler or reinforcer preferably to be selected from the group of glass beads or solid or hollow glass beads, or glass fibers, or ground glass, amorphous quartz glass, aluminum borosilicate glass having an alkali content of 1% (E glass), amorphous silica, quartz flour, calcium silicate, calcium metasilicate, magnesium carbonate, kaolin, calcined kaolin, chalk, kyanite, powdered or ground quartz, mica, phlogopite, barium sulfate, feldspar, wollastonite, montmorillonite, pseudoboehmite of the formula AlO(OH), magnesium carbonate and talc, especially glass fibers, and
E) 0.01 to 2 parts by mass of at least one thermal stabilizer, preferably to be selected from the group of sterically hindered phenols, in particular those containing at least one 2,6-di-tert-butylphenyl group and/or 2-tert-butyl-6-methylphenyl group, furthermore phosphites, hypophosphites, especially sodium hypophosphite NaH₂PO₂, hydroquinones, aromatic secondary amines and 3,3′-thiodipropionates,
with the proviso that the high-voltage components or high-voltage components for electromobility in the RAL color system correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003. Preference is given to using titanium dioxide as component E).

Preference is given in accordance with the invention to high-voltage components, especially high-voltage components for electromobility, based on polymer compositions comprising

A) per 100 parts by mass of at least one polyamide, preferably nylon-6 or nylon-6,6, especially nylon-6,
B) 0.01 to 5 parts by mass of at least cerium(III)sulfide (Ce₂S₃) or cerium(III)sulfide/lanthanum(III)sulfide,
C) 1 to 150 parts by mass of at least one filler and reinforcer preferably to be selected from the group of glass beads or solid or hollow glass beads, or glass fibers, or ground glass, amorphous quartz glass, aluminum borosilicate glass having an alkali content of 1% (E glass), amorphous silica, quartz flour, calcium silicate, calcium metasilicate, magnesium carbonate, kaolin, calcined kaolin, chalk, kyanite, powdered or ground quartz, mica, phlogopite, barium sulfate, feldspar, wollastonite, montmorillonite, pseudoboehmite of the formula AlO(OH), magnesium carbonate and talc, especially glass fibers, and
E) 0.01 to 2 parts by mass of at least one thermal stabilizer, preferably to be selected from the group of sterically hindered phenols, in particular those containing at least one 2,6-di-tert-butylphenyl group and/or 2-tert-butyl-6-methylphenyl group, furthermore phosphites, hypophosphites, especially sodium hypophosphite NaH₂PO₂, hydroquinones, aromatic secondary amines and 3,3′-thiodipropionates,
with the proviso that the high-voltage components or high-voltage components for electromobility, in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003. Preference is given to using titanium dioxide as component E).

Preference is given in accordance with the invention to high-voltage components, especially high-voltage components for electromobility, based on polymer compositions comprising

A) per 100 parts by mass of at least one polyamide, preferably nylon-6 or nylon-6,6, especially nylon-6,
B) 0.01 to 5 parts by mass of at least one sulfide containing cerium,
C) 1 to 150 parts by mass of at least one filler and reinforcer preferably to be selected from the group of glass beads or solid or hollow glass beads, or glass fibers, or ground glass, amorphous quartz glass, aluminum borosilicate glass having an alkali content of 1% (E glass), amorphous silica, quartz flour, calcium silicate, calcium metasilicate, magnesium carbonate, kaolin, calcined kaolin, chalk, kyanite, powdered or ground quartz, mica, phlogopite, barium sulfate, feldspar, wollastonite, montmorillonite, pseudoboehmite of the formula AlO(OH), magnesium carbonate and talc, especially glass fibers,
D) 3 to 100 parts by mass of at least one flame retardant additive, preferably to be selected from mineral flame retardants, nitrogen-containing flame retardants or phosphorus-containing flame retardants, and
E) 0.01 to 2 parts by mass of at least one thermal stabilizer, preferably to be selected from the group of sterically hindered phenols, in particular those containing at least one 2,6-di-tert-butylphenyl group and/or 2-tert-butyl-6-methylphenyl group, furthermore phosphites, hypophosphites, especially sodium hypophosphite NaH₂PO₂, hydroquinones, aromatic secondary amines and 3,3′-thiodipropionates,
with the proviso that the high-voltage components or high-voltage components for electromobility in the RAL color system correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003. Preference is given to using titanium dioxide as component E).

Preference is given in accordance with the invention to high-voltage components, especially high-voltage components for electromobility, based on polymer compositions comprising

A) per 100 parts by mass of at least one polyamide, preferably nylon-6 or nylon-6,6, especially nylon-6,
B) 0.01 to 5 parts by mass of at least cerium(III)sulfide (Ce₂S₃) or cerium(III)sulfide/lanthanum(III)sulfide,
C) 1 to 150 parts by mass of at least one filler or reinforcer preferably to be selected from the group of glass beads or solid or hollow glass beads, or glass fibers, or ground glass, amorphous quartz glass, aluminum borosilicate glass having an alkali content of 1% (E glass), amorphous silica, quartz flour, calcium silicate, calcium metasilicate, magnesium carbonate, kaolin, calcined kaolin, chalk, kyanite, powdered or ground quartz, mica, phlogopite, barium sulfate, feldspar, wollastonite, montmorillonite, pseudoboehmite of the formula AlO(OH), magnesium carbonate and talc, especially glass fibers,
D) 3 to 100 parts by mass of at least one flame retardant additive, preferably to be selected from mineral flame retardants, nitrogen-containing flame retardants or phosphorus-containing flame retardants, and
E) 0.01 to 2 parts by mass of at least one thermal stabilizer, preferably to be selected from the group of sterically hindered phenols, in particular those containing at least one 2,6-di-tert-butylphenyl group and/or 2-tert-butyl-6-methylphenyl group, furthermore phosphites, hypophosphites, especially sodium hypophosphite NaH₂PO₂, hydroquinones, aromatic secondary amines and 3,3′-thiodipropionates,
with the proviso that the high-voltage components or high-voltage components for electromobility, in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003. Preference is given to using titanium dioxide as component E).

Process

The present invention additionally relates to a process for producing the polymer compositions to be used in high-voltage components, especially in high-voltage components for electromobility, in that A) at least one polyamide and B) at least one sulfide containing cerium, and optionally at least one of the further components C), D) or E) are mixed with one another in at least one mixing system, with the proviso that the high-voltage components or high-voltage components for electromobility, in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003. Preference is given here to using, for every 100 parts by mass of at least one polyamide, 0.01 to 5 parts by mass of at least one sulfide containing cerium. Preferred sulfides containing cerium are cerium(III) sulfide (Ce₂S₃) or cerium(III) sulfide/lanthanum(III) sulfide.

The present invention additionally relates to a process for producing high-voltage components, especially high-voltage components for electromobility, in that the polymer compositions are processed further by injection molding, including the special methods of GIT (gas injection methodology), WIT (water injection methodology) and PIT (projectile injection methodology), by extrusion methods, including profile extrusion, or by blow molding. Optionally, the polymer compositions, prior to further processing, are extruded to strands, cooled until pelletizable, optionally dried and pelletized. In one embodiment, the polymer composition is stored intermediately in pelletized form.

The invention preferably relates to a process for producing high-voltage components, especially high-voltage components for electromobility, in that A) at least one polyamide and B) at least one sulfide containing cerium, preferably 0.01 to 5 parts by mass of at least one sulfide containing cerium per 100 parts by mass of at least one polyamide, are mixed with one another to give polymer compositions, discharged to give strands, cooled until pelletizable and pelletized, and the polymer compositions are then processed further by injection molding, including the special methods of GIT (gas injection methodology), WIT (water injection methodology) and PIT (projectile injection methodology), by extrusion methods, including profile extrusion, or by blow molding, with the proviso that the high-voltage components or high-voltage components for electromobility, in the RAL color system, correspond to color number RAL2003, RAL2004, RAL2007, RAL2008, RAL2009, RAL2010 or RAL2011, more preferably to color numbers RAL2003, RAL2004, RAL2008 or RAL2009, most preferably to color number RAL 2003. Preferred sulfides containing cerium are cerium(III)sulfide (Ce₂S₃) or cerium(III)sulfide/lanthanum(III)sulfide.

High-Voltage Components

Preferred high-voltage components, especially high-voltage components for electromobility, find use in electrical drivetrains and/or in battery systems. Particularly preferred high-voltage components are covers for electrics or electronics, control devices, covers/housings for fuses, relays, battery cell modules, fuse holders, fuse plugs, terminals, cable holders or sheathings, in particular sheathings of high-voltage bus bars.

### EXAMPLES

To demonstrate the improvements in properties described in accordance with the invention, corresponding polyamide-based polymer compositions were first made up by compounding. For this purpose, the individual components were mixed in a twin-screw extruder ((ZSK 25 Compounder from Coperion Werner & Pfleiderer (Stuttgart, Germany)) at temperatures between 270 and 300° C., discharged as a strand, cooled until pelletizable and pelletized. After drying (generally for two days at 80° C. in a vacuum drying cabinet), the pellets were processed at temperatures in the range from 270 to 290° C. to give standard test specimens for the respective tests.

In the context of the present experiments, bleeding was measured via the discoloration of a 30.20.2 mm³ plasticized PVC film (P-PVC, FB110 white, standard low temperature strength, from Jedi Kunststofftechnik GmbH, Eitorf, Germany), which was stored in a hot air drying cabinet at 80° C. for 12 hours clamped between two 60·40·2 mm³ plastic sheets based on the polymer compositions shown in Table 2. This was followed by visual evaluation according to the gray scale of ISO 105-A02, with ‘5’ meaning that the PVC film showed no color change and ‘1’ meaning that the PVC film showed a significant color change.

In the context of the present invention, a measure of lightfastness was considered to be the discoloration of the molding compounds described in Table 2 in the form of 60.40.2 mm³ sheets after storage under UV with UV light from Suntest CPS+, 300-800 nm, 45-130 klx, with window glass filter 250-765 W/m² from Atlas Material Testing Technology GmbH, Linsengericht, Germany, for 96 h. Discoloration was evaluated visually based on the blue wool scale according to DIN EN ISO 105-B02, with ‘8’ representing exceptional lightfastness (little color change) and ‘1’ representing very low lightfastness (significant color change).

A measure of the quality of laser inscribability at 1064 nm was considered in the context of the present invention to be the contrast of a surface treated with a laser beam compared to a surface not treated with the laser beam. For this purpose, the DPL-Genesis-Marker (8W) laser inscription device from ACI Laser GmbH, Chemnitz, Germany was used, which was equipped with the MagicMarkV3 inscription software and the focusing lens F-Theta 163. An Nd:YAG laser crystal functioned as laser therein and delivered laser light of wavelength 1064 nm. For comparison of the contrast after inscription, a writing speed of 100 mm/s, a pulse frequency of 1000 Hz and a line spacing of 100 μm were chosen, with a pulse width of 3 μs and a laser power of the device of 90%.

Contrast was classified as follows, using the gray scale according to ISO 105-A03:
Classification (−): The laser-irradiated surface differed from the non-laser-irradiated surface, comparable to a gray scale according to ISO 105-A03 of class 4, 4/5 or 5. The laser-irradiated surface was thus barely distinguishable, if at all, from the non-laser-irradiated surface.
Classification (+): The laser-irradiated surface differed from the non-laser-irradiated surface, comparable to a gray scale according to ISO 105-A03 of classes 1 to 3/4. The laser-irradiated surface was thus readily distinguishable from the non-laser-irradiated surface.

Comparative Tracking Index was determined in accordance with IEC 60112 on test specimens of dimensions 60 mm 40 mm 4 mm using test solution A as defined in chapter 7.3 of IEC60112 at a voltage of 600 V, using 100 droplets rather than 50 droplets for the test in a departure from the standard. The numerical result of 101 drops means that none of the failure criteria of chapter 8.3 of IEC 60112 has occurred at 100 drops.

Reactants:
Component A) Nylon-6 (Durethan® B26, from Lanxess Deutschland GmbH, Cologne, Germany)
Component B1): Cerium(III) sulfide/lanthanum(III) sulfide (CAS No. 12014-93-6; CAS No. 12031-49-1) [C.I. Pigment Orange 78 (Neolor Light Orange S from Baotou Hongbo Te Technology co. Ltd., ‘Inner Mongolia’, China)
Component E/1): Titanium dioxide [CAS No. 13463-67-7] (Sachtleben R-KB-4 from Venator Germany GmbH, Duisburg)
Component X/1): 12H-Phthaloperin-12-one [CAS No. 6925-69-5] in the form of Macrolex® Orange 3G from Lanxess Deutschland GmbH, Cologne.

TABLE II

| | | Ex. 1 | Comp. 1 |
|---|---|---|---|
| Component A) | Pts. by wt. | 100 | 100 |
| Component B1) | Pts. by wt. | 0.3 | |
| Component B2) | Pts. by wt. | | |
| Component E1) | Pts. by wt. | 0.3 | 0.3 |
| Component X/1 | Pts. by wt. | | 0.3 |
| Bleeding | Gray scale | 5 | 4 |
| Lightfastness | Blue scale | 8 | 6 |
| Laser contrast 1064 nm | Classification | + | − |
| CTI A @ 600 V | Number of | 101 | — |
| | drops | | |

The results in Tab. II show that only inventive Ex. 1, coupled with simultaneously high light fastness and very low tendency to bleeding, also showed sufficiently good contrast after laser inscription at 1064 nm, whereas the colorants according to the prior art did not simultaneously have both good contrast and good light fastness and a low tendency to bleeding.

1. A polymer composition comprising A) at least one polyamide and B) at least one sulfide containing cerium.

2. The polymer composition as claimed in claim 1, wherein
for every 100 parts by mass of at least one polyamide,
0.01 to 5 parts by mass of at least one sulfide containing cerium are used.

3. The polymer composition as claimed in claim 1, wherein at least cerium(III) sulfide or cerium(III) sulfide/lanthanum(III) sulfide is used.

4. The polymer composition as claimed in claim 1, further comprising C) at least one filler or reinforcer, with the proviso that the polymer compositions, in the RAL color system, correspond to color number RAL2003, RAL2004, RAL2007, RAL2008, RAL2009, RAL2010 or RAL2011.

5. The polymer composition as claimed in claim 1, further comprising D) at least one flame retardant, or further comprising both the component D) and C) at least one filler or reinforcer, with the proviso that the polymer compositions, in the RAL color system, correspond to color number RAL2003, RAL2004, RAL2007, RAL2008, RAL2009, RAL2010 or RAL2011.

6. The polymer composition as claimed in claim 1, comprising E) at least one further additive other than a filler or reinforcer or flame retardant, or further comprising the component E) and one or both of D) at least one flame retardant and C) at least one filler or reinforcer, with the proviso that the polymer compositions, in the RAL color system, correspond to color number RAL2003, RAL2004, RAL2007, RAL2008, RAL2009, RAL2010 or RAL2011.

7. The polymer composition as claimed in claim 4, wherein the filler or reinforcer is selected from the group of glass beads or solid or hollow glass beads, or glass fibers, ground glass, amorphous quartz glass, aluminum borosilicate glass having an alkali metal content of 1%, amorphous silica, quartz flour, calcium silicate, calcium metasilicate, magnesium carbonate, kaolin, calcined kaolin, chalk, kyanite, powdered or ground quartz, mica, phlogopite, barium sulfate, feldspar, wollastonite, montmorillonite, pseudoboehmite of the formula AlO(OH), magnesium carbonate and talc.

8. The polymer composition as claimed in claim 5, wherein the flame retardant is selected from mineral flame retardants, nitrogen-containing flame retardants and phosphorus-containing flame retardants.

9. The polymer composition as claimed in claim 6, wherein at least one thermal stabilizer is used as additive E).

10. The polymer composition as claimed in claim 6, wherein titanium dioxide is used as additive E).

11. The polymer composition as claimed in claim 1, wherein nylon-6, nylon-6,6, nylon-4,6 and/or a semiaromatic copolyamide is/are used as polyamide.

12. A high-voltage component comprising the polymer composition as claimed in claim 1.

13. The high-voltage component as claimed in claim 12, wherein the component comprises covers for electrics or electronics, control devices, covers/housings for fuses, relays, battery cell modules, fuse holders, fuse plugs, terminals, cable holders or sheathings.

14. A process for producing the polymer composition as claimed in claim 1, comprising mixing the components A) and B), optionally with one or more components chosen from C) at least one filler or reinforcer, D) at least one flame retardant and E) at least one further additive other than a filler or reinforcer or flame retardant, in at least one mixing system, with the proviso that the polymer composition, in the RAL color system, corresponds to color number RAL2003, RAL2004, RAL2007, RAL2008, RAL2009, RAL2010 or RAL2011.

15. A process for producing high-voltage components, comprising mixing A) at least one polyamide and B) at least one sulfide containing cerium to give polymer compositions that are discharged to give strands, cooling and pelletizing the resulting polymer compositions, and further processing the compositions by injection molding, by extrusion methods, or by blow molding.

16. A method of marking a polyamide-based product, comprising irradiating the product using a laser, wherein at least one sulfide containing cerium is used in the polyamide.

17. The polymer composition as claimed in claim 4, wherein the at least one filler or reinforcer C) is present in an amount of 1 to 150 parts by mass, based on 100 parts by mass of the component A).

18. The polymer composition as claimed in claim 5, wherein the at least one flame retardant D) is present in an amount of 3 to 100 parts by mass, based on 100 parts by mass of the component A).

19. The polymer composition as claimed in claim 6, wherein the at least one further additive E) is present in an amount of 0.01 to 80 parts by mass, based on 100 parts by mass of the component A).

20. The process as claimed in claim 15, wherein 0.01 to 5 parts by mass of the sulfide containing cerium is used per 100 parts by mass of polyamide.
